(19) United States
(12) Patent Application Publication
(10) Pub. No.: US 2024/0402896 A1
(43) Pub. Date: Dec. 5, 2024

(54) METHOD, APPARATUS, TERMINAL AND STORAGE MEDIUM FOR INFORMATION PROCESSING

(71) Applicant: Beijing Zitiao Network Technology Co., Ltd., Beijing (CN)

(72) Inventors: Qingyu LAI, Beijing (CN); Yiping ZHENG, Beijing (CN); Chaoyi ZHANG, Beijing (CN)

(21) Appl. No.: 18/699,107

(22) PCT Filed: Sep. 30, 2022
(86) PCT No.: PCT/CN2022/123394

§ 371 Date: Apr. 5, 2024

(30) Foreign Application Priority Data
Oct. 8, 2021 (CN) 202111172202.0

(51) Int. Cl. G06F 3/04847; G06F 3/04855

(52) U.S. Cl. CPC G06F 3/04847; G06F 3/04855

(57) ABSTRACT

A method, apparatus, terminal and storage medium for information processing. The method for information processing includes: in response to a first predetermined operation on a first control of a first document, displaying a control panel corresponding to the first control, the control panel comprising at least one second control (101); in response to a second predetermined operation on the control panel, determining whether a distance between the first control or the control panel and a page edge of the first document is greater than a predetermined threshold (102); and if the distance is greater than or equal to the predetermined threshold, expanding a display area of the control panel and displaying a third control in the expanded display area (103). The method for information processing greatly improves the efficiency of information interaction.

### CROSS REFERENCE

The present application claims priority to Chinese Patent Application No. 202111172202.0, filed on Oct. 8, 2021 and entitled “Method, apparatus, terminal and storage medium for information processing”, the entirety of which is incorporated herein by reference.

### FIELD

The present disclosure relates to the field of information technology, and more particularly to a method, apparatus, terminal and a storage medium for information processing.

### BACKGROUND

In the editing of some document (such as online documents), it is usually necessary to display some control panels. Due to the limited display area of the control panel, the display area can only display some controls in the control panel and controls that have not yet been displayed are displayed through sliding operations, etc. Therefore, the controls arranged in the back need to be slid for a certain distance to be displayed, resulting in higher interaction costs. Further improvements are expected.

### SUMMARY

In order to solve the existing problems, the present disclosure provides a method, apparatus, terminal and storage medium for information processing.

The present disclosure adopts the following technical solution.

An embodiment of the present disclosure provides a method for information processing, comprising: in response to a first predetermined operation on a first control of a first document, displaying a control panel corresponding to the first control, the control panel comprising at least one second control; in response to a second predetermined operation on the control panel, determining whether a distance between the first control or the control panel and a page edge of the first document is greater than a predetermined threshold; and if the distance is greater than or equal to the predetermined threshold, expanding a display area of the control panel and displaying a third control in an expanded display area.

Another embodiment of the present disclosure provides an apparatus for information processing, the information processing apparatus comprising: a control panel displaying module configured to, in response to a first predetermined operation on a first control of a first document, display a control panel corresponding to the first control, the control panel comprising at least one second control; a determining module configured to, in response to a second predetermined operation on the control panel, determining whether a distance between the first control or the control panel and a page edge of the first document is greater than a predetermined threshold; and a controlling module configured to, if the distance is greater than or equal to the predetermined threshold, expanding a display area of the control panel and displaying a third control in an expanded display area.

In some embodiments, the present disclosure provides a terminal, comprising: at least one memory and at least one processor; wherein the memory is used to store program code and the processor is used to call the program code stored in the memory to perform the above method for information processing.

In some embodiments, the present disclosure provides a storage medium, wherein the storage medium is used to store program code and the program code is used to perform the above method for information processing.

Embodiments of the present disclosure determine whether the distance between the first control or the control panel and the page edge of the first document is greater than a predetermined threshold, if the distance is greater than or equal to the predetermined threshold, the display area of the control panel is expanded and the third control is displayed, so that the efficiency of information exchange is greatly improved.

### BRIEF DESCRIPTION OF THE DRAWINGS

In conjunction with the accompanying drawings and with reference to the following detailed description, the above and other features, advantages and aspects of the various embodiments of the present disclosure will become more apparent. Throughout the drawings, like or similar reference numerals denote like or similar elements. It should be understood that the drawings are illustrative and that elements and elements are not necessarily drawn to scale.

FIG. 1 is a flowchart of a method for information processing of an embodiment of the present disclosure.

FIGS. 2 and 3 respectively illustrate schematic diagrams of an editing interface of a first document of some embodiments of the present disclosure.

FIG. 4 is a part of modules of an apparatus for information processing of some embodiments of the present disclosure.

FIG. 5 is a schematic structural diagram of an electronic device of an embodiment of the present disclosure.

### DETAILED DESCRIPTION

The embodiments of the present disclosure will be described in more detail below with reference to the accompanying drawings. Although some embodiments of the present disclosure are shown in the accompanying drawings, it should be understood that the present disclosure may be implemented in various forms and should not be construed as being limited to the embodiments described herein, on the contrary, these embodiments are provided for a more thorough and complete understanding of the present disclosure. It should be understood that the accompanying drawings and embodiments of the disclosure are merely illustrative, rather than limiting the scope of protection of the disclosure.

It should be understood that the steps described in the embodiments of the disclosure may be performed according to different orders and/or in parallel. In addition, the embodiments may include additional steps and/or omit the execution of the shown steps. The scope of the disclosure is not limited in this aspect.

The term “comprising” and its variations used herein are open-ended, i.e. “comprising but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in the present disclosure are only used to distinguish different apparatuses, modules, or units, and are not used to limit the order or interdependence of the functions performed by these apparatuses, modules, or units.

It should be noted that the modification of “one” mentioned in the present disclosure is illustrative and not restrictive. Those skilled in the art should understand it as “one or more” unless otherwise specified in the context.

Names of messages or information interacted among a plurality of apparatuses in the embodiments of the disclosure are merely for an illustrative purpose, rather than limiting the scope of these messages or information.

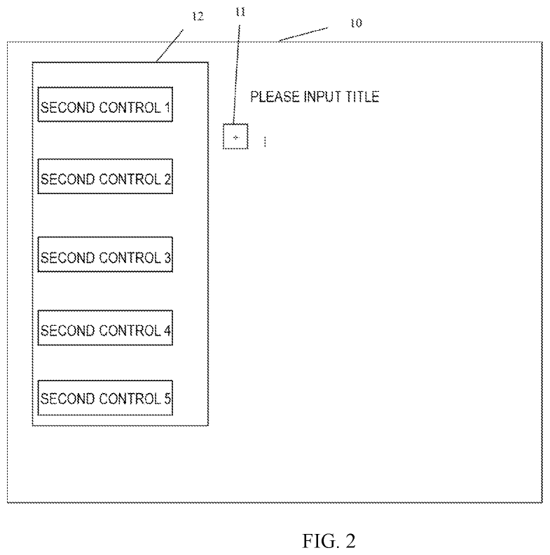

A predetermined control (for example, a first control, the plus sign control 11 shown in FIG. 2) is usually an entry for adding content to a document. By performing a predetermined operation on the predetermined control (such as hovering or clicking), the control panel (such as the control panel 12 shown in FIG. 2) is displayed, and various functional controls can be displayed on the control panel in a vertical arrangement. In terms of sorting the controls, it can be from “basic” to “advanced”. Due to the limited display area of the control panel, the controls with higher frequencies are generally presented in a more forward position to highlight the highlights. This makes the controls arranged in the back need to scroll multiple times or slide a certain distance to be displayed, and the interaction cost of the controls arranged in the back to be seen is higher, and the efficiency of inserting content is also lower.

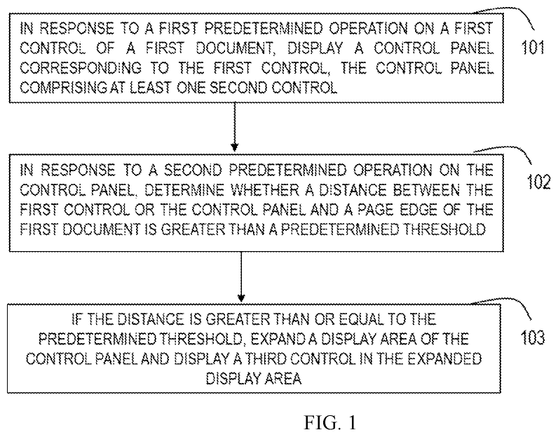

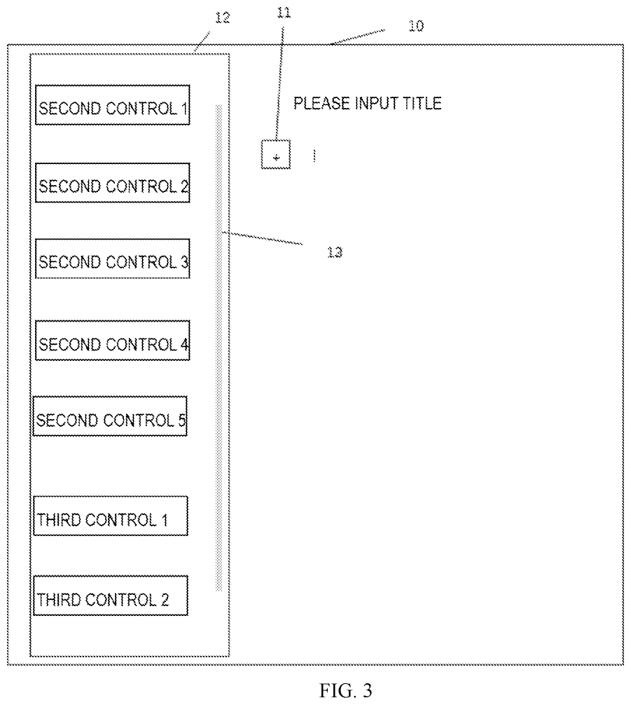

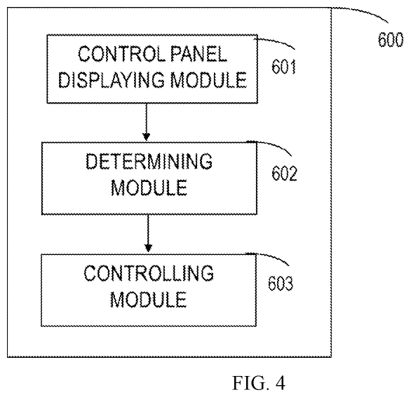

FIG. 1 provides a flow chart of a method for information processing of an embodiment of the present disclosure. FIGS. 2 and 3 respectively illustrate schematic diagrams of an editing interface of a first document of some embodiments of the present disclosure. The method for information processing of the present disclosure can include step 101, in response to a first predetermined operation on a first control 11 of a first document 10, display a control panel 12 corresponding to the first control 11, the control panel 12 comprising at least one second control. In some embodiments, the first document 10 is an online document, and during the editing process of the first document 10, the first control 11 can be used as an entry for adding content. In some embodiments, the first predetermined operation may include appropriate operations such as hovering, clicking, and long pressing. For example, taking the computer client as an example, when the mouse hovers over the first control 11 (e.g., stays for a predetermined duration, e.g., stays for Is) or clicks on the first control 11, the corresponding control panel 12 is displayed. In some embodiments, the control panel 12 includes at least one second control, wherein a portion of the controls (e.g., a third control) may be temporarily hidden because the display area is too small. When a sliding operation is performed in the control panel 12, the hidden controls may be displayed, and the displayed portion of the second control may be hidden.

In some embodiments, the method of the present disclosure may further comprise step 102, in response to a second predetermined operation on the control panel 12, determine whether a distance between the first control 11 or the control panel 12 and a page edge of the first document 10 is greater than a predetermined threshold. In some embodiments, the second predetermined operation may include suitable operations such as sliding a touch or scrolling a mouse wheel and the like. For example, when a cursor of the mouse is above the control panel 12, scrolling (down) the mouse wheel. In some embodiments, the predetermined threshold may be set in advance or automatically set by the system, e.g., 1 cm, etc.

In some embodiments, the method of the present disclosure may further comprise step 103, if the distance is greater than or equal to the predetermined threshold, expand a display area of the control panel 12 and display a third control in the expanded display area. In some embodiments, if the distance is greater than or equal to the predetermined threshold, it indicates that the display area of the control panel is allowed to be expanded at this time, thereby expanding the display area of the control panel 12 and displaying the third control, as shown in FIG. 3. In some embodiments, the second control and the third control may be the same type of control (e.g., both are data processing-related controls), or different types of controls (e.g., the second control is a data processing-related control, and the third control is a drawing-related control).

Embodiments of the present disclosure determines whether the distance between the first control 11 and the page edge of the first document 10 is greater than a predetermined threshold, if the distance is greater than or equal to the predetermined threshold value, the display area of the control panel 12 is expanded and a third control is displayed, thereby greatly improving the efficiency of information interaction.

In some embodiments, the page edge corresponds to an extending direction of the control panel 12. In some embodiments, the page edge refers to the edge of the document page corresponding to the extending direction of the control panel 12. For example, when the controls of the control panel 12 are arranged vertically and the control panel 12 extends from the vicinity of the first control 11 to the bottom of the page, the page edge is the bottom edge of the page; on the contrary, if the control panel 12 extends from the vicinity of the first control 11 to the top of the page, the page edge is the top edge of the page. Similarly, when the functional controls of the control panel 12 are arranged horizontally and the control panel 12 extends from the vicinity of the first control 11 to the left side of the page, the page edge is the left edge of the page; on the contrary, if the control panel 12 extends from the vicinity of the first control 11 to the right side of the page, the page edge is the right edge of the page.

In some embodiments, if the distance is greater than or equal to the predetermined threshold value, a control in the control panel 12 slides with the second predetermined operation while expanding the display area of the control panel 12 and displaying the third control in the expanded display area. For example, when sliding down the control panel 12, the display area of the control panel 12 expands and can display the previously hidden third control, while the controls in the control panel 12 slide down with the second predetermined operation. Definitely, this is only an example, when the controls in the control panel 12 are arranged horizontally and for example, the second predetermined operation is to slide the control panel 12 to the right, the controls in the control panel 12 slide to the right with the second predetermined operation. That is, when the second predetermined operation causes the control to slide, the display area of the control panel is also expanded, so that the previously hidden third control can be displayed, thereby greatly improving the efficiency of information interaction. In addition, by expanding the display area of the control panel 12 while sliding the controls, more controls can be displayed with limited sliding, greatly improving information efficiency, providing more exposure possibilities for controls arranged behind at the same time, and improving the efficiency of inserting document content through the control panel.

In some embodiments, if the distance is less than the predetermined threshold, it indicates that there is no expansion space for the control panel at this time, so that the display area of the control panel 12 does not expand and can remain unchanged. In some embodiments, if the distance is less than the predetermined threshold, the controls in the control panel 12 slide with the second predetermined operation. Therefore, when the display area of the control panel 12 is not expanded, in order to display some hidden controls (such as the third control), the controls in the control panel 12 slide with the second predetermined operation, so that some hidden controls can be displayed, and some displayed controls can be temporarily hidden.

As shown in FIG. 3, in some embodiments, when the controls in the control panel 12 slide with the second predetermined operation, the scroll bar 13 is displayed at a predetermined position of the control panel 12. For example, when the controls in the control panel 12 are arranged vertically, the controls in the control panel 12 can slide vertically accordingly when the sliding operation is performed on the control panel 12, and the scroll bar 13 can be displayed at a right position in the control panel 12. In some embodiments, the scroll bar 13 can slide with the second predetermined operation (e.g., sliding up and down). In some embodiments, the length of the scroll bar 13 can reflect the number of controls in the control panel 12. The more controls in the control panel 12, generally the shorter the length of the scroll bar 13.

In some embodiments, the control panel 12 includes a plurality of control areas, controls in the control panel 12 are located in corresponding areas according to their respective properties. For example, in some embodiments, the controls in the control panel 12 are arranged in groups. For example, the controls can be grouped and arranged according to their functional properties, so that users can find the required controls efficiently.

In some embodiments, in response to a third predetermined operation on the control panel 12, cause a control in the control panel 12 to slide with the third predetermined operation without hiding the expanded display area of the control panel. In some embodiments, the third predetermined operation is an opposite operation to the second predetermined operation, for example, when the second predetermined operation is to slide down the control panel 12, the third predetermined operation is to slide up the control panel 12. Similarly, when the second predetermined operation is to slide right the control panel 12, the third predetermined operation is to slide left the control panel 12. For example, as shown in FIG. 3, the functional controls are arranged vertically, the second predetermined operation can be sliding down the control panel 12, and the third predetermined operation can be sliding up the control panel 12. At this time, the controls in the control panel 12 can slide up or down with the third predetermined operation, and the expanded display area of the control panel 12 is not hidden, to display more controls and improve the efficiency of information interaction.

In some embodiments, some controls (e.g., a fourth control) comprises a plurality of sub-controls, and the method for information processing further comprising: in response to a fourth predetermined operation on the fourth control, displaying a plurality of sub-controls in the sub-control panel. In some embodiments, the fourth predetermined operation may include appropriate operations such as staying for a predetermined duration, click and the like. By displaying a plurality of sub-controls in the manner of the sub-control panel, on the one hand, more functions can be integrated in the control, and on the other hand, the controls and the corresponding sub-controls are displayed in a hierarchical manner, which facilitates the user's operation and enhances the user's interactive experience.

An embodiment of the present disclosure also provides an apparatus for information processing 600 that includes a control panel displaying module 601, a determining module 602, and a controlling module 603. In some embodiments, the control panel displaying module 601 is configured to, in response to a first predetermined operation on a first control of a first document, display a control panel corresponding to the first control, the control panel comprising at least one second control. In some embodiments, the determining module 602 is configured to, in response to a second predetermined operation on the control panel, determine whether a distance between the first control or the control panel and a page edge of the first document is greater than a predetermined threshold. In some embodiments, the controlling module 603 is configured to, if the distance is greater than or equal to the predetermined threshold, expand a display area of the control panel and displaying a third control in an expanded display area.

It should be understood that the content described about the method for information processing also applies to the apparatus information processing 600 used herein. For simplicity, it will not be described in detail here.

In some embodiments, the page edge corresponds to an extending direction of the control panel. In some embodiments, if the distance is greater than or equal to the predetermined threshold value, a control in the control panel slides with the second predetermined operation while expanding the display area of the control panel and displaying the third control in the expanded display area. In some embodiments, if the distance is less than the predetermined threshold, the display area of the control panel remains unchanged and a control in the control panel slides with the second predetermined operation. In some embodiments, while a control in the control panel slides with the second predetermined operation, a scroll bar is displayed at a predetermined position of the control panel. In some embodiments, the control panel comprises a plurality of control areas, and controls in the control panel are located in corresponding areas according to their respective properties. In some embodiments, the controlling module is further configured to, in response to a third predetermined operation on the control panel, causing a control in the control panel to slide with the third predetermined operation without hiding the expanded display area of the control panel.

In addition, the present disclosure further provides a terminal, comprising: at least one memory and at least one processor; wherein the memory is used to store program code, and the processor is used to call the program code stored in the memory to perform the above method for information processing.

In addition, the present disclosure further provides a computer storage medium, which stores program code, and the program code is used to perform the above method for information processing.

Based on embodiments and application examples, the method and apparatus for information processing of the present disclosure are described. In addition, the present disclosure also provides a terminal and a storage medium, which are described below.

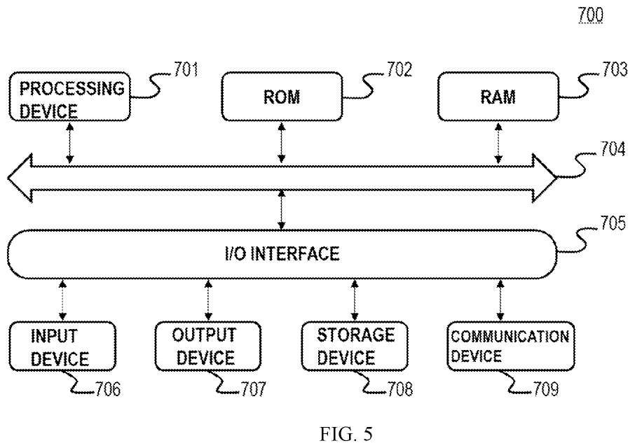

Now referring to FIG. 5, a structural schematic diagram of electronic device (such as a terminal device or a server)700 suitable for implementing an embodiment of the disclosure is shown. The terminal device in the embodiment of the present disclosure can include, but is not limited to, mobile terminals such as a mobile phone, a notebook computer, a digital broadcast receiver, a PDA (personal digital assistant), a Pad (tablet computer), a PMP (portable media player) and a vehicle-mounted terminal (e.g., vehicle-mounted navigation terminal), and fixed terminals such as a digital TV and a desktop computer. The electronic device shown in FIG. 5 is only an example, and should not bring any restrictions on the functions and application scope of the embodiments of the present disclosure.

As shown in FIG. 5, the electronic device 700 may include a processing device (e.g., central processor, graphics processor, etc.) 701 that may perform various appropriate actions and processes based on programs stored in read-only memory (ROM) 702 or loaded into random access memory (RAM) 703 from the storage device 708. Also stored in RAM 703 are various programs and data required for the operation of electronic device 700. The processing device 701, ROM 702, and RAM 703 are connected to each other via bus 704. The input/output (I/O) interface 705 is also connected to the bus 704.

Typically, the following devices can be connected to I/O interface 705: input device 706 including, for example, touch screens, touch pads, keyboards, mice, cameras, microphones, accelerometers, gyroscopes, etc.; output device 707 including, for example, liquid crystal displays (LCDs), speakers, vibrators, etc.; storage device 708 including, for example, magnetic tapes, hard drives, etc.; and communication device 709. The communication device 709 can allow the electronic device 700 to communicate with other devices by wire or wireless to exchange data. Although FIG. 5 shows the electronic device 700 with various devices, it should be understood that it is not required to implement or provide all the devices shown. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program carried on a computer readable medium, the computer program comprising program code for performing the method shown in the flowchart. In such an embodiment, the computer program may be downloaded and installed from a network via a communication device 709, or from a storage device 708, or from a ROM 702. When this computer program is executed by the processing device 701, the above-described functions as defined in the method of embodiments of the present disclosure are performed.

It is to be noted that the computer-readable medium described above in this disclosure may be a computer-readable signal medium or a computer-readable storage medium or any combination of the above. The computer readable storage medium may be, for example—but not limited to—an electrical, magnetic, optical, electromagnetic, infrared, or semiconductor system, device, or device, or any combination of the above. More specific examples of computer-readable storage media may include, but are not limited to: electrically connected with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, or any of the above, magnetic memory devices, or any suitable combination of the foregoing. In the present disclosure, a computer-readable storage medium may be any tangible medium that contains or stores a program that may be used by or in combination with an instruction execution system, device, or device. And in the present disclosure, a computer-readable signal medium may include a data signal propagated in the baseband or as part of a carrier wave that carries computer-readable program code. Such propagated data signals may take a variety of forms, including but not limited to electromagnetic signals, optical signals, or any suitable combination of the foregoing. Computer-readable signal medium can also be any computer-readable medium other than computer-readable storage media, the computer-readable signal medium can send, propagate or transmit the program for use by or in combination with the instruction execution system, device or device. The program code contained on the computer-readable medium may be transmitted using any suitable medium, including but not limited to: wire, fiber optic cable, RF (radio frequency), etc., or any suitable combination of the above.

In some implementations, the client, server may communicate using any currently known or future developed network protocol such as HTTP (HyperText Transfer Protocol), and may interconnect with any form or medium of digital data communication (e.g., a communication network). Examples of communication networks include local area networks (“LAN”), wide area networks (“WAN”), inter-networks (e.g., the Internet), and end-to-end networks (e.g., ad hoc end-to-end networks), as well as any currently known or future developed networks.

The above computer-readable medium may be contained in the above electronic device; or it may be present separately and not assembled into the electronic device.

The above computer readable medium carries one or more programs which, when executed by the electronic device, cause the electronic device to perform the methods of the present disclosure as described above.

Computer program code for performing the operations of the present disclosure may be written in one or more programming languages or combinations thereof, including object-oriented programming languages—such as Java, Smalltalk, C++, and also including conventional procedural programming languages—such as “C” language or similar programming languages. The program code may be executed entirely on the user's computer, partially on the user's computer, as a stand-alone package, partially on the user's computer and partially on a remote computer, or entirely on a remote computer or server. In the case of a remote computer, the remote computer may be connected to the user computer over any kind of network—including a local area network (LAN) or a wide area network (WAN)—or, alternatively, may be connected to an external computer (e.g., using an Internet service provider to connect over the Internet).

The flowcharts and block diagrams in the accompanying drawings illustrate the possible implementations of the architecture, functionality, and operation of systems, methods, and computer program products in accordance with various embodiments of the present disclosure. At this point, each box in a flowchart or block diagram may represent a module, program segment, or portion of code that contains one or more executable instructions for implementing a specified logical function. It should also be noted that in some implementations as replacements, the functions indicated in the boxes may also occur in a different order than that indicated in the accompanying drawings. For example, two boxes represented one after the other can actually be executed in substantially parallel, and they can sometimes be executed in the opposite order, depending on the function involved. Note also that each box in the block diagram and/or flowchart, and the combination of boxes in the block diagram and/or flowchart, may be implemented with a dedicated hardware-based system that performs the specified function or operation, or may be implemented with a combination of dedicated hardware and computer instructions.

The units described in the embodiments of the present disclosure may be implemented by means of software, or by means of hardware. Wherein, the name of the unit does not in some cases constitute a limitation on the unit itself.

The functions described above herein may be performed, at least in part, by one or more hardware logic components. For example, non-limitingly, example types of hardware logic components that may be used include: field-programmable gate arrays (FPGA), application-specific integrated circuits (ASIC), application-specific standard products (ASSP), systems-on-chip (SOC), complex programmable logic devices (CPLD), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. Machine readable media may include, but are not limited to, electronic, magnetic, optical, electromagnetic, infrared, or semiconductor systems, devices, or equipment, or any suitable combination of the foregoing. More specific examples of machine-readable storage media would include one or more wire-based electrical connections, portable computer disks, hard disks, random access memory (RAM), read-only memory (ROM), erasable programmable read-only memory (EPROM or flash memory), optical fiber, convenient compact disk read-only memory (CD-ROM), optical storage devices, magnetic storage devices, or any suitable combination of the above any suitable combination of the above.

According to one or more embodiments of the present disclosure, there is provided a method for information processing, comprising: in response to a first predetermined operation on a first control of a first document, displaying a control panel corresponding to the first control, the control panel comprising at least one second control; in response to a second predetermined operation on the control panel, determining whether a distance between the first control or the control panel and a page edge of the first document is greater than a predetermined threshold; and if the distance is greater than or equal to the predetermined threshold, expanding a display area of the control panel and displaying a third control in the expanded display area.

According to one or more embodiments of the present disclosure, the page edge corresponds to an extending direction of the control panel.

According to one or more embodiments of the present disclosure, if the distance is greater than or equal to the predetermined threshold value, a control in the control panel slides with the second predetermined operation while expanding the display area of the control panel and displaying the third control in the expanded display area.

According to one or more embodiments of the present disclosure, if the distance is less than the predetermined threshold, the display area of the control panel remains unchanged and a control in the control panel slides with the second predetermined operation.

According to one or more embodiments of the present disclosure, while a control in the control panel slides with the second predetermined operation, a scroll bar is displayed at a predetermined position of the control panel.

According to one or more embodiments of the present disclosure, the control panel comprises a plurality of control areas, and controls in the control panel are located in corresponding areas according to their respective properties.

According to one or more embodiments of the present disclosure, the method for information processing further comprising: in response to a third predetermined operation on the control panel, causing a control in the control panel to slide with the third predetermined operation without hiding the expanded display area of the control panel.

According to one or more embodiments of the present disclosure, there is provided an apparatus for information processing comprising: a control panel displaying module configured to, in response to a first predetermined operation on a first control of a first document, display a control panel corresponding to the first control, the control panel comprising at least one second control; a determining module configured to, in response to a second predetermined operation on the control panel, determine whether a distance between the first control or the control panel and a page edge of the first document is greater than a predetermined threshold; and a controlling module configured to, if the distance is greater than or equal to the predetermined threshold, expand a display area of the control panel and displaying a third control in an expanded display area.

According to one or more embodiments of the present disclosure, there is provided a terminal, comprising: at least one memory and at least one processor; wherein the at least one memory is used to store program code, and the at least one processor is used to call the program code stored in the at least one memory to perform the method according to any of the above.

According to one or more embodiments of the present disclosure, there is provided a storage medium is used to store program code, and the program code is used to perform the method described above.

The above description is only a better embodiment of the present disclosure and a description of the technical principles applied. It should be understood by those skilled in the art that the scope of the disclosure covered by the present disclosure is not limited to technical solutions formed by specific combinations of the above technical features, but should also cover other technical solutions formed by any combination of the above technical features or their equivalent features without departing from the above disclosed idea. For example, the above features are interchangeable with (but not limited to) technical features with similar functions disclosed in the present disclosure.

Further, while the operations are depicted in a particular order, this should not be construed as requiring that the operations be performed in the particular order shown or in sequential order. Multitasking and parallel processing may be advantageous in certain environments. Again, while several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments individually or in any suitable sub-combination.

Although the present subject matter has been described using language specific to structural features and/or method logical actions, it should be understood that the subject matter as defined in the appended claims is not necessarily limited to the particular features or actions described above. Rather, the particular features and actions described above are merely example forms of claim fulfillment.

1. A method for information processing, comprising:
in response to a first predetermined operation on a first control of a first document, displaying a control panel corresponding to the first control, the control panel comprising at least one second control;
in response to a second predetermined operation on the control panel, determining whether a distance between the first control or the control panel and a page edge of the first document is greater than a predetermined threshold; and
if the distance is greater than or equal to the predetermined threshold, expanding a display area of the control panel and displaying a third control in the expanded display area.

2. The method for information processing of claim 1, wherein the page edge corresponds to an extending direction of the control panel.

3. The method for information processing of claim 1, wherein if the distance is greater than or equal to the predetermined threshold value, a control in the control panel slides with the second predetermined operation while expanding the display area of the control panel and displaying the third control in the expanded display area.

4. The method for information processing of claim 1, wherein if the distance is less than the predetermined threshold, the display area of the control panel remains unchanged and a control in the control panel slides with the second predetermined operation.

5. The method for information processing of claim 1, wherein while a control in the control panel slides with the second predetermined operation, a scroll bar is displayed at a predetermined position of the control panel.

6. The method for information processing of claim 1, wherein the control panel comprises a plurality of control areas, and controls in the control panel are located in corresponding areas according to their respective properties.

7. The method for information processing of claim 1, further comprising: in response to a third predetermined operation on the control panel, causing a control in the control panel to slide with the third predetermined operation without hiding the expanded display area of the control panel.

8. (canceled)

9. A terminal, comprising:
at least one memory and at least one processor;
wherein the at least one memory is used to store program code, and the at least one processor is used to call the program code stored in the at least one memory to perform acts comprising:
in response to a first predetermined operation on a first control of a first document, displaying a control panel corresponding to the first control, the control panel comprising at least one second control;
in response to a second predetermined operation on the control panel, determining whether a distance between the first control or the control panel and a page edge of the first document is greater than a predetermined threshold; and
if the distance is greater than or equal to the predetermined threshold, expanding a display area of the control panel and displaying a third control in the expanded display area.

10. A storage medium, wherein the storage medium is used to store program code and the program code is used to perform acts comprising:
in response to a first predetermined operation on a first control of a first document, displaying a control panel corresponding to the first control, the control panel comprising at least one second control;
in response to a second predetermined operation on the control panel, determining whether a distance between the first control or the control panel and a page edge of the first document is greater than a predetermined threshold; and
if the distance is greater than or equal to the predetermined threshold, expanding a display area of the control panel and displaying a third control in the expanded display area.

11. The method for information processing of claim 1, wherein a fourth control comprises a plurality of sub-controls and the method further comprises:
in response to a fourth predetermined operation on the fourth control, displaying a plurality of sub-controls in the sub-control panel.

12. The method for information processing of claim 1, wherein the page edge indicates an edge of a document page corresponding to the extending direction of the control panel.

13. The method for information processing of claim 7, the third predetermined operation is an opposite operation to the second predetermined operation.

14. The terminal of claim 9, wherein the page edge corresponds to an extending direction of the control panel.

15. The terminal of claim 9, wherein if the distance is greater than or equal to the predetermined threshold value, a control in the control panel slides with the second predetermined operation while expanding the display area of the control panel and displaying the third control in the expanded display area.

16. The terminal of claim 9, wherein if the distance is less than the predetermined threshold, the display area of the control panel remains unchanged and a control in the control panel slides with the second predetermined operation.

17. The terminal of claim 9, wherein while a control in the control panel slides with the second predetermined operation, a scroll bar is displayed at a predetermined position of the control panel.

18. The terminal of claim 9, wherein the control panel comprises a plurality of control areas, and controls in the control panel are located in corresponding areas according to their respective properties.

19. The terminal of claim 9, the acts further comprising: in response to a third predetermined operation on the control panel, causing a control in the control panel to slide with the third predetermined operation without hiding the expanded display area of the control panel.

20. The terminal of claim 9, wherein a fourth control comprises a plurality of sub-controls and the acts further comprises:
in response to a fourth predetermined operation on the fourth control, displaying a plurality of sub-controls in the sub-control panel.

21. The terminal of claim 9, wherein the page edge indicates an edge of a document page corresponding to the extending direction of the control panel.
